(19) United States
(12) Patent Application Publication
(10) Pub. No.: US 2020/0077803 A1
(43) Pub. Date: Mar. 12, 2020

(54) SEAT AND POSTURE ESTIMATION SYSTEM

(71) Applicant: TOYOTA BOSHOKU KABUSHIKI KAISHA, Aichi (JP)

(72) Inventor: Nobuki HAYASHI, Aichi (JP)

(73) Assignee: TOYOTA BOSHOKU KABUSHIKI KAISHA, Aichi (JP)

(21) Appl. No.: 16/564,446

(22) Filed: Sep. 9, 2019

(30) Foreign Application Priority Data
Sep. 12, 2018 (JP) 2018-170490

(51) Int. Cl. A47C 31/12; B60N 2/02; A47C 1/12

(52) U.S. Cl. CPC A47C 31/126; B60N 2/0244; B60N 2002/0272; B60N 2002/0268; A47C 1/12

(57) ABSTRACT

A seat is provided which enables real-time estimation of a posture of a seated person. One aspect of the present disclosure provides a seat including a seat main body, at least one 3-axis acceleration sensor arranged in the seat main body, and an estimation device that estimates a posture of a seated person on the seat main body. The estimation device includes a storage that stores a learning model built by machine learning of input data based on a sensor output from the at least one 3-axis acceleration sensor and teacher data based on information on the posture of the seated person or a posture transition of the seated person, and an estimator that uses the learning model to estimate the posture of the seated person or the posture transition of the seated person from the sensor output.

### CROSS-REFERENCE TO RELATED APPLICATIONS

This application claims the benefit of Japanese Patent Application No. 2018-170490 filed on Sep. 12, 2018 with the Japan Patent Office, the entire disclosure of which is incorporated herein by reference.

### BACKGROUND

The present disclosure relates to a seat and a posture estimation system.

Customer service can be improved by knowing a posture of a seated person on a seat installed in facilities or vehicles and providing information, utility and the like suitable to a current situation of the seated person.

As a way of knowing the posture of the seated person, there is a known detection system using a pressure-sensor, such as a membrane switch (see Japanese Unexamined Patent Application Publication No. 2003-61779).

### SUMMARY

The detection system using the pressure-sensor as above detects a static state and cannot directly detect a transition of the posture of the seated person. In addition, there is a limit to a speed of response to a posture change.

In one aspect of the present disclosure, it is preferable to provide a seat that enables real-time estimation of a posture of a seated person.

One aspect of the present disclosure provides a seat comprising a seat main body, at least one 3-axis acceleration sensor arranged in the seat main body, and an estimation device that estimates a posture of a seated person on the seat main body.

The estimation device includes a storage and an estimator. The storage stores a learning model built by machine learning of input data based on a sensor output from the at least one 3-axis acceleration sensor, and teacher data based on information on the posture of the seated person or a posture transition of the seated person. The estimator uses the learning model to estimate the posture of the seated person or the posture transition of the seated person from the sensor output.

According to the configuration as such, the posture of the seated person can be estimated in real time by the estimation device having the learning model based on 3-dimensional acceleration data outputted from the 3-axis acceleration sensor.

The 3-axis acceleration sensor is lower in cost than a pressure-sensor. Further, since use of the 3-axis acceleration sensor can reduce measurement points of the sensor (that is, the number of sensors) as compared to a case of using a pressure-sensor, an amount of data to process can be reduced. As a result, cost of the seat can be reduced.

In one aspect of the present disclosure, the teacher data may be based on the information on the posture of the seated person. The estimator may estimate the posture of the seated person from the sensor output. According to the configuration as such, the current posture of the seated person can be easily confirmed.

In one aspect of the present disclosure, the estimator may use the learning model to attach a posture label to the input data. The posture label may be a combination of information on an upper body posture of the seated person, information on a waist posture of the seated person, and information on a leg posture of the seated person. According to the configuration as such, a seating position, a body tilt, a relaxation degree and the like of the seated person can be estimated. Therefore, more appropriate service can be provided.

In one aspect of the present disclosure, the at least one 3-axis acceleration sensor may include a first cushion acceleration sensor, a second cushion acceleration sensor, and a back acceleration sensor. The seat main body may include a seat cushion and a seatback. The first cushion acceleration sensor and the second cushion acceleration sensor may be arranged in the seat cushion, spaced apart from each other in a width direction of the seat cushion. The back acceleration sensor may be arranged in the seatback. According to the configuration as such, a posture to provide a suitable service can be estimated with minimum necessary sensors.

Another aspect of the present disclosure provides a posture estimation system comprising a seat main body, at least one 3-axis acceleration sensor arranged in the seat main body, and an estimation device that estimates a posture of a seated person on the seat main body.

The estimation device includes a storage and an estimator. The storage stores a learning model built by machine learning of input data based on a sensor output from the at least one 3-axis acceleration sensor, and teacher data based on information on the posture of the seated person or a posture transition of the seated person. The estimator uses the learning model to estimate the posture of the seated person or the posture transition of the seated person from the sensor output.

According to the configuration as such, the posture of the seated person can be estimated in real time by the estimation device including the learning model based on 3-dimensional acceleration data outputted from the 3-axis acceleration sensor.

### DESCRIPTION OF THE DRAWINGS

An example embodiment of the present disclosure will be described hereinafter with reference to the accompanying drawings, in which:

FIG. 1 is a schematic diagram showing a seat in an embodiment;

FIG. 2 is a schematic diagram showing one example of learning model used by the seat in FIG. 1;

FIG. 3 is a schematic diagram explaining a correspondence relationship between a posture of a seated person and an output of an acceleration sensor in the seat in FIG. 1;

FIG. 4 is a flow diagram schematically showing a process executed by an estimator in the seat in FIG. 1;

FIG. 5 is a schematic diagram showing a seat in a different embodiment from the embodiment of FIG. 1.

### DETAILED DESCRIPTION OF THE PREFERRED EMBODIMENTS

### 1. First Embodiment

### 1-1. Configuration

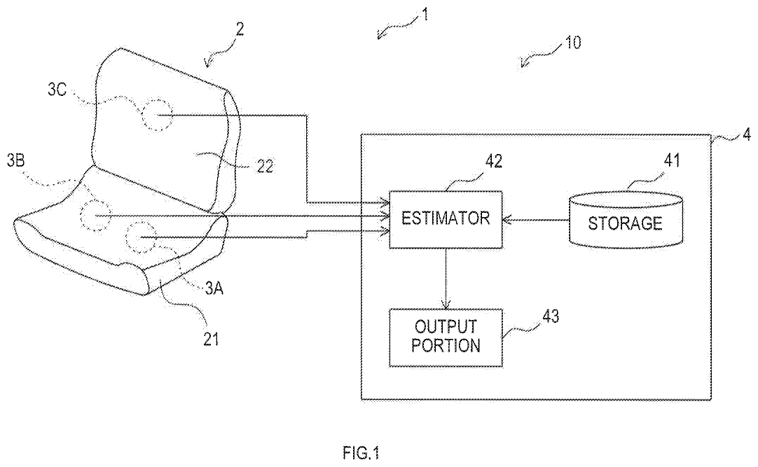

A seat 1 and a posture estimation system 10 shown in FIG. 1 are installed in facilities such as stadiums, movie theaters, theaters, concert halls, and live houses, or in vehicles such as motor vehicles, railway vehicles, ships and boats, and aircrafts.

Each of the seat 1 and the posture estimation system 10 comprises a seat main body 2, a first cushion acceleration sensor 3A, a second cushion acceleration sensor 3B, a back acceleration sensor 3C, and an estimation device 4.

<Seat Main Body>

The seat main body 2 includes a seat cushion 21 and a seatback 22. The seat cushion 21 supports the buttocks and the like of a seated person S. The seatback 22 supports the back of the seated person S.

The first cushion acceleration sensor 3A and the second cushion acceleration sensor 3B to be described later are arranged in the seat cushion 21. The back acceleration sensor 3C to be described later is arranged in the seatback 22.

<Acceleration Sensor>

Each of the first cushion acceleration sensor 3A, the second cushion acceleration sensor 3B, and the back acceleration sensor 3C is a 3-axis acceleration sensor which is configured to output 3-dimensional acceleration data.

The first cushion acceleration sensor 3A, the second cushion acceleration sensor 3B, and the back acceleration sensor 3C may have a function of detecting 3-axis angular velocity (that is, roll angular velocity, pitch angular velocity, and yaw angular velocity) as required.

If posture estimation is implemented without using the angular velocity as the input data in the estimation device 4 to be described later, it is preferable that each acceleration sensor has a function of detecting only acceleration, from the viewpoint of reducing sensor cost and power consumption.

The first cushion acceleration sensor 3A and the second cushion acceleration sensor 3B are buried in the seat cushion 21, spaced apart from each other in a width direction of the seat cushion 21, that is, side by side in a left-right direction.

Specifically, the first cushion acceleration sensor 3A is arranged on the right side of a width direction center of the seat cushion 21. The second cushion acceleration sensor 3B is arranged on the left side of the width direction center of the seat cushion 21.

Each of the first cushion acceleration sensor 3A and the second cushion acceleration sensor 3B is arranged so as to overlap with a hip point (that is, outermost part of femur) of the seated person S. Also, a distance in the left-right direction between the first cushion acceleration sensor 3A and the second cushion acceleration sensor 3B is, for example, 100 mm or more and 150 mm or less.

The back acceleration sensor 3C is buried in the seatback 22. The back acceleration sensor 3C is arranged in a width direction center of the seatback 22. The back acceleration sensor 3C has a height, for example, obtained by adding a height of 150 mm or more and 400 mm or less to the hip point.

<Estimation Device>

The estimation device 4 estimates a posture of the seated person S on the seat main body 2. The estimation device 4 may be attached to or incorporated in the seat main body 2, or may be arranged spaced apart from the seat main body 2.

The estimation device 4 includes a storage 41, an estimator 42, and an output portion 43. The estimation device 4 is configured, for example, by a microcomputer including a microprocessor, a storage medium such as a RAM and a ROM, and an input/output portion.

<Storage>

The storage 41 stores a learning model built by machine learning of input data based on sensor outputs from the first cushion acceleration sensor 3A, the second cushion acceleration sensor 3B and the back acceleration sensor 3C, and teacher data (that is, label data) based on information on the posture of the seated person S or a posture transition of the seated person S.

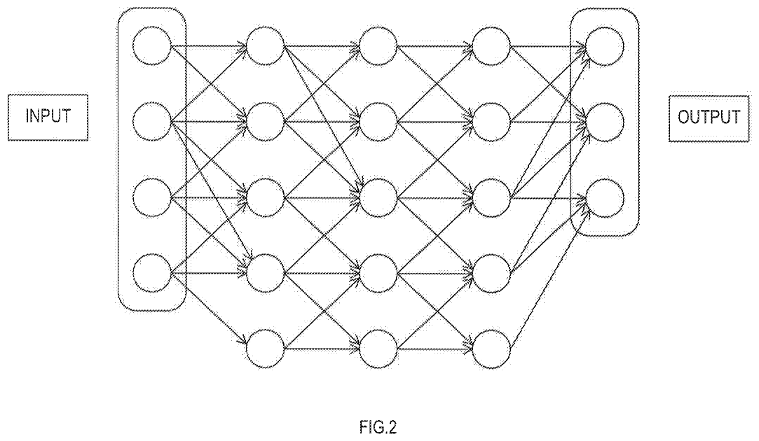

This learning model is a classifier (that is, classification model) built by supervised machine learning, and is configured, for example, by a multilayer neural network shown in FIG. 2. Examples of the multilayer neural network include CNN (Convolution Neural Network), DNN (Deep Neural Network), LSTM (Long Short-Term Memory) and the like.

The learning model is not limited to multilayer neural networks. Models other than neural networks may be used. For example, algorithms such as SVC (classification by a support vector machine), random forest, and the like may be used to build the learning model.

In the machine learning of the learning model stored in the storage 41, an output of each acceleration sensor (that is, 3-dimensional acceleration or acceleration data obtained by adding 3-dimensional angular velocity to the 3-dimensional acceleration) is used as the input data. As the teacher data, a specified number of posture labels showing posture patterns of the seated person S or a specified number of posture transition labels showing transition patterns of the posture of the seated person S are used.

The learning model is built using a machine learning device (not shown). The learning model built by the machine learning device is outputted to the storage 41. The machine learning device may be incorporated in the estimation device 4.

In a learning step to generate the learning model, a large number of labeled data is analyzed by the machine learning device. The labeled data is the acceleration data attached with a corresponding posture label or posture transition label. The machine learning device learns a feature amount for classifying the acceleration data into multiple labels from the large number of labeled data so as to build the learning model.

<Estimator>

The estimator 42 uses the learning model stored in the storage 41 to estimate the posture of the seated person S and/or the posture transition of the seated person S from the sensor output of each acceleration sensor.

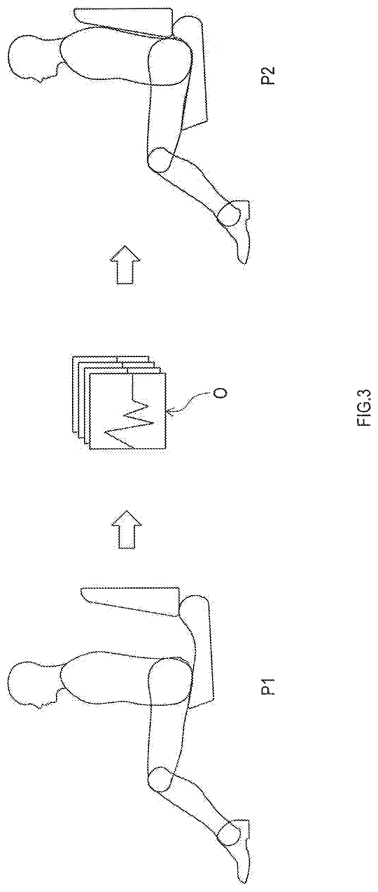

As shown in FIG. 3, for example, when the posture of the seated person S transitions from a posture P1 where the seated person S sits on the front edge of the seat main body 2 to a posture P2 where the seated person S sits back in the seat main body 2, the estimator 42 inputs a sensor output O at the time of transition to the learning model having the posture label as the teacher data, and attaches the posture label of “sitting back” to the input data. As a result, the posture of the seated person S which is “sitting back” is estimated.

Alternately, the estimator 42 inputs the sensor output O to the learning model having the posture transition label as the teacher data, and attaches the posture transition label of “reseating oneself in the back” to the input data. As a result, the posture transition of the seated person S which is “reseating oneself in the back” is estimated.

The posture label attached to the input data by the estimator 42 is one of predefined posture patterns to be estimated. The posture label of the present embodiment is a combination of upper body information on an upper body posture of the seated person S, waist information on a waist posture of the seated person S, and leg information on a leg posture of the seated person S.

The upper body information is a combination of upper body front-back information and upper body left-right information. The upper body front-back information represents, for example, one of upper body postures of “leaning forward (that is, head is positioned before the front edge of the seat main body 2)”, “straight without leaning on the seatback 22” and “leaning on the seatback 22”. The upper body left-right information represents, for example, one of upper body postures of “tilted to right”, “not tilted”, and “tilted to left”.

The waist information represents, for example, one of back postures of “closer to front than the seat cushion 21 center” and “closer to back than the seat cushion 21 center”.

The leg information represents, for example, one of leg postures of “straight down from knees”, “legs stretched out” and “crossed”.

Also in the present embodiment, the posture transition label attached to the input data by the estimator 42 is a combination of the upper body information on an upper body transition of the seated person S, waist information on a waist transition of the seated person S, and leg information on a leg transition of the seated person S.

The upper body information of the posture transition label is a combination of the upper body front-back information and the upper body left-right information. The upper body front-back information represents, for example, one of upper body transition states of “moving forward”, “moving backward” and “stationary”. The upper body left-right information represents, for example, one of upper body transition states of “moving to right”, “moving to left” and “stationary”.

The waist information represents, for example, one of waist transition states of “moving forward”, “moving backward” and “stationary”. The leg information represents, for example, one of leg transition states of “moving under the knees”, “moving forward”, “lifted up” and “stationary”.

The posture transition label is a combination of the upper body front-back information, the upper body left-right information, the waist information and the leg information. For example, the posture transition label with the upper body front-back information of “moving forward”, the upper body left-right information of “stationary”, the waist information of “moving forward” and the leg information of “stationary” represents a state in which “the seated person S while leaning forward reseats oneself on the front edge of the seat main body 2”.

Each information described above which constitutes the posture label and posture transition label is an example. Such information can be changed, added or removed in accordance with the posture of the seated person S intended to be estimated.

The estimator 42 inputs a sensor output obtained within a specified measurement time, for example, at a specified interval (that is, sampling time) of around 10 ms to the learning model to estimate the posture or the posture transition. The measurement time is determined as required in accordance with a speed of possible movement of the seated person S, which is, for example, one to two seconds.

<Output Portion>

The output portion 43 outputs the posture or the posture transition of the seated person S estimated by the estimator 42 to a display device, a storage medium, a service system and the like (not shown).

The service system which receives the output from the output portion 43, provides a service such as information, utility and the like suitable to the current state of the seated person S, based on the information on the received posture or posture transition of the seated person S.

### 1-2. Processing

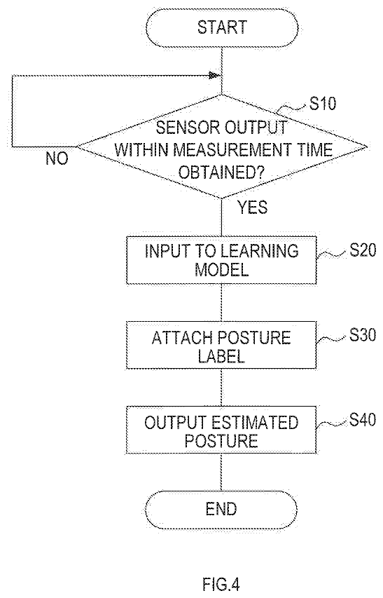

Referring to a flow diagram in FIG. 4, a process executed by the estimator 42 to estimate the posture of the seated person S will be described hereinafter. The learning model in the process below can be changed as required when the estimator 42 estimates the posture transition of the seated person S.

The present process starts after the estimator 42 obtains the sensor output. First, the estimator 42 determines whether the sensor output within the specified measurement time (one second, for example) has been obtained (Step S10).

When the sensor output within the measurement time has been obtained (S10: YES), the sensor output is inputted to the learning model as the input data (Step S20). If the sensor output within the measurement time has not been obtained (S10: NO), the estimator 42 waits until the sensor output within the measurement time is obtained.

The estimator 42, after the input of the sensor output, uses the learning model to attach the posture label to the input data (Step S30). Then, the estimator 42 outputs to the output portion 43 the posture label attached to the input data as an estimated posture of the seated person S (Step S40).

### 1-3. Effect

According to the above-detailed embodiment, the following effect can be obtained.

(1a) The posture of the seated person S can be estimated in real time by the estimation device 4 with the learning model based on the 3-dimensional acceleration data outputted from the acceleration sensors 3A, 3B and 3C.

(1b) The acceleration sensors 3A, 3B and 3C are low in cost than a pressure-sensor. Further, as compared to a case of using a pressure-sensor, measurement points of the sensor (that is, the number of sensors) can be reduced. Thus, an amount of data to process is reduced. As a result, cost of the seat 1 and the posture estimation system 10 can be reduced.

(1c) Use of the posture label, which is a combination of the information on the upper body posture, information on the waist posture, and information on the leg posture of the seated person S in the estimator 42, enables estimation of a seating position, a body tilt, a degree of relaxation and the like of the seated person S. Thus, more appropriate service can be provided.

(1d) Use of the first cushion acceleration sensor 3A, the second cushion acceleration sensor 3B, and the back acceleration sensor 3C enables estimation of a posture to provide a suitable service with minimum necessary sensors.

### 2. Other Embodiments

The embodiment of the present disclosure has been described above. However, the present disclosure is not limited to the above-described embodiments and can be modified variously.

(2a) In the seat 1 and the posture estimation system 10 of the above-described embodiment, the posture label attached to the input data by the estimator 42 may not be a combination of the information on the upper body posture, information on the waist posture, and information on the leg posture of the seated person S. Similarly, the posture transition label attached to the input data by the estimator 42 may not be a combination of the information on the upper body transition, information on the waist transition, and information on the leg transition of the seated person S.

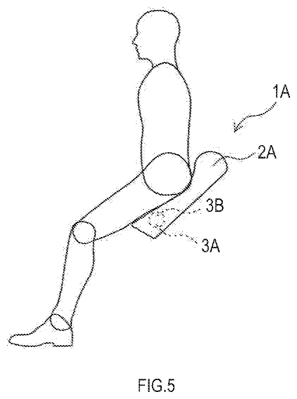

For example, a seat 1A shown in FIG. 5 does not include a back acceleration sensor, since a seat main body 2A does not have a seatback. In the seat 1A, the posture label does not have to include information on the upper body posture.

(2b) In the seat 1 and the posture estimation system 10 of the above-described embodiment, the number of 3-axis acceleration sensors may be one, two, or four or more. For example, in the above seat 1A in FIG. 5, only two cushion acceleration sensors 3A and 3B are arranged in the seat main body 2A.

(2c) In the seat 1 and the posture estimation system 10 of the above-described embodiment, the estimator 42 may estimate the posture transition by the learning model, and thereafter may estimate the latest posture of the seated person S, based on the estimated posture transition and the posture of the seated person S before the transition.

(2d) A function achieved by one element in the above-described embodiments may be divided into two or more elements. A function achieved by two or more elements may be integrated into one element. Further, a part of the configuration of any of the above-described embodiments may be omitted. At least a part of the configuration of any of the above-described embodiments may be added to or replaced with the configuration of the other embodiments described above. It should be noted that any and all modes that are encompassed in the technical ideas defined by the languages in the scope of the claims are embodiments of the present disclosure.

What is claimed is:

1. A seat comprising:
a seat main body;
at least one 3-axis acceleration sensor arranged in the seat main body; and
an estimation device that estimates a posture of a seated person on the seat main body,
the estimation device comprising:
a storage that stores a learning model built by machine learning of input data based on a sensor output from the at least one 3-axis acceleration sensor and teacher data based on information on the posture of the seated person or a posture transition of the seated person; and
an estimator that uses the learning model to estimate the posture of the seated person or the posture transition of the seated person from the sensor output.

2. The seat according to claim 1, wherein
the teacher data is based on the information on the posture of the seated person, and
the estimator estimates the posture of the seated person from the sensor output.

3. The seat according to claim 2, wherein
the estimator uses the learning model to attach a posture label to the input data, the posture label being a combination of information on an upper body posture of the seated person, information on a waist posture of the seated person, and information on a leg posture of the seated person.

4. The seat according to claim 3, wherein
the at least one 3-axis acceleration sensor comprises;
a first cushion acceleration sensor;
a second cushion acceleration sensor; and
a back acceleration sensor,
wherein the seat main body comprises a seat cushion and a seatback,
the first cushion acceleration sensor and the second cushion acceleration sensor are arranged in the seat cushion, spaced apart from each other in a width direction of the seat cushion, and
the back acceleration sensor is arranged in the seatback.

5. A posture estimation system comprising:
a seat main body;
at least one 3-axis acceleration sensor arranged in the seat main body; and
an estimation device that estimates a posture of a seated person on the seat main body,
the estimation device comprising:
a storage that stores a learning model built by machine learning of input data based on a sensor output from the at least one 3-axis acceleration sensor and teacher data based on information on the posture of the seated person or a posture transition of the seated person; and
an estimator that uses the learning model to estimate the posture of the seated person or the posture transition of the seated person from the sensor output.
